(19) United States
(12) Patent Application Publication
(10) Pub. No.: US 2019/0120202 A1
(43) Pub. Date: Apr. 25, 2019

(54) POWER-GENERATING APPARATUS AND METHOD

(71) Applicant: Gary Richard Churchill, Toronto (CA)

(72) Inventor: Gary Richard Churchill, Toronto (CA)

(21) Appl. No.: 15/789,857

(22) Filed: Oct. 20, 2017

(51) Int. Cl. F03D 1/04; F03D 9/11; F03D 9/34; F03D 9/32; F03D 9/25; H02K 7/18

(52) U.S. Cl. CPC F03D 1/04; F03D 9/11; H02K 7/183; F03D 9/32; F03D 9/25; F03D 9/34

(57) ABSTRACT

A power-generating apparatus includes a wind power-generator, a curtain-frame coupled to the wind power-generator, and at least one support-pole attachable to the curtain-frame. The power-generating apparatus is useful for being anchored along a shoreline above an expected storm-surge, and for generating renewable energy. The device is designed to withstand storm forces.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of power generators of existing art and more specifically relates to a wind turbine power generator.

### Related Art

A storm is any disturbed state of an environment and strongly implies severe weather. It may be marked by significant disruptions to normal conditions such as strong wind and rain. It is common for storms or hurricanes to be generated in the ocean, and move towards land masses. Storm-surges or coastal flooding may often accompany low-pressure storms moving towards land masses. With strong winds provided by storms, increase in renewable energy may be available.

Solar power, wind power and others are used as new and renewable energies. A wind turbine is a device that converts the wind's kinetic energy into electrical power. Wind turbine devices are erected on high pillars to capture the wind. These pillars often require a large amount of maintenance and are not collecting the most amount of wind possible. It is therefore desired to utilize wind turbines during storms and to avoid potential damage by storm-surges.

U.S. Pub. No. 2014/0306457 to Yong-Tak Kim relates to a curtain-suspension-type power-generating apparatus. The described curtain-suspension-type power-generating apparatus includes a curtain-suspension-type power-generating apparatus in which generator bodies, i.e., turbines using the force of the wind, are vertically and densely suspended from upper and lower wire ropes connected in parallel, such that the generator bodies rotate along the upper and lower wire ropes. The curtain-suspension-type power-generating apparatus comprises: a plurality of curved turbine blades which rotate by means of the wind blowing from the outside; a generator coupled in a straight line to the center of the turbine blades; an upper wire rope and a lower wire rope connected between the upper ends or lower ends of steel towers such that the upper wire rope and the lower wire rope are arranged in parallel; and a plurality of generator bodies densely installed at the upper and lower wire ropes arranged in parallel. The number of the wire ropes having the plurality of generator bodies installed thereon may be one, two, three, or more connected together so as to form a radial shape. The thus-configured curtain-suspension-type power-generating apparatus may easily generate electrical energy in any place in which there is wind, and may mass-produce electrical energy.

### SUMMARY OF THE INVENTION

In view of the foregoing disadvantages inherent in the known wind turbine power generator art, the present disclosure provides a novel power-generating apparatus. The general purpose of the present disclosure, which will be described subsequently in greater detail, is to provide a power-generating apparatus and method.

A power-generating apparatus is disclosed herein. The power-generating apparatus includes a wind power-generator. The wind power-generator may include a body having turbine-blades. A curtain-frame may be coupled to the wind power-generator. The curtain-frame may have a cone-collector configured to funnel wind to the wind power-generator, and a battery for storing the power collected from the wind power-generator. At least one support-pole may be attachable to the curtain-frame, and configured to support the curtain-frame in a suspended state. The at least one support-pole may have a weighted-stabilizer attached for adjustment to the curtain-frame. The present disclosure may be advantageous by providing the power generating apparatus which may be configured to be anchored along a shoreline of a body of water above an expected storm-surge.

According to another embodiment, a method of using a power-generating apparatus is also disclosed herein. The method of using the power-generating apparatus includes providing a wind power-generator; the wind power-generator including a body having turbine-blades, a curtain-frame coupled to the wind power-generator, and at least one support-pole attachable to the curtain-frame, anchoring the at least one support-pole above an expected storm-surge, and generating power from the wind power-generator.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a power-generating apparatus and method, constructed and operative according to the teachings of the present disclosure.

FIG. 1 is a perspective view of the power-generating apparatus anchored to a shoreline, according to an embodiment of the disclosure.

FIG. 2 is a perspective view of the power-generating apparatus of FIG. 1, according to an embodiment of the present disclosure.

FIG. 3 is a perspective view of the power-generating apparatus of FIG. 1, according to an embodiment of the present disclosure.

FIG. 4 is a perspective view of the power-generating apparatus of FIG. 1, according to an embodiment of the present disclosure.

FIG. 5 is a flow diagram illustrating a method of using a power-generating apparatus, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a wind turbine power generator and more particularly to a power-generating apparatus and method as used to improve the generation of power from renewable sources (i.e. kinetic energy), particularly above an expected storm-surge.

Generally, hurricanes are accompanied by a large amount of kinetic energy potential. Therefore, a solution of utilizing wind-turbines to harvest this energy is desired. The present invention in this disclosure may be arranged in an array with one or more wind-turbines attached to curtains for two reasons: reduce damage to the wind-turbines and reduce wind speed along the shoreline. Infrastructures built along the shoreline may be protected by such an arrangement. Damage may decrease and energy harvested may increase which is desirable.

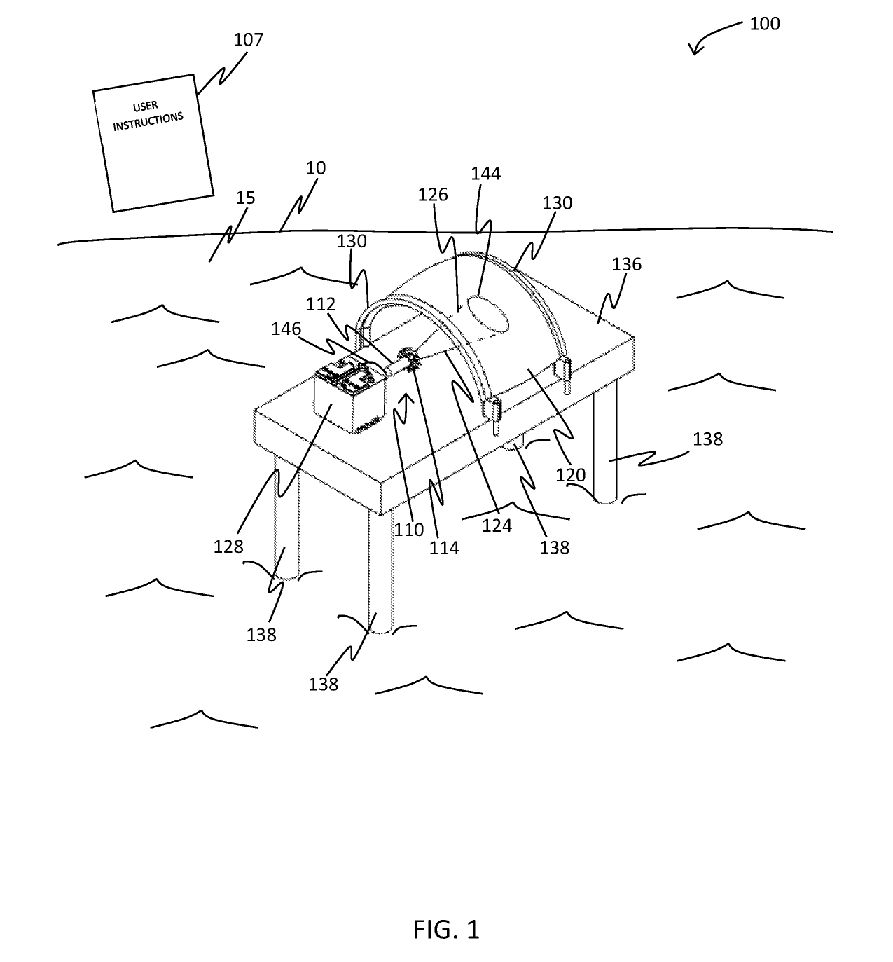

Referring now more specifically to the drawings by numerals of reference, there is shown in FIGS. 1-4, various views of a power-generating apparatus 100.

FIG. 1 shows the power-generating apparatus 100 anchored along a shoreline, according to an embodiment of the present disclosure. Here, the power-generating apparatus 100 may be beneficial to gather kinetic energy from a storm-surge via a wind power-generator 110. As illustrated, the power-generating apparatus 100 may include the wind power-generator 110. The wind power-generator 110 may include a body 112 having turbine-blades 114. The turbine-blades 114 may be rotateably mounted to the body 112 of the wind power-generator 110. A curtain-frame 120 may be coupled to the wind power-generator 110 via a cone-collector 122. The curtain-frame 120 may include an aperture 144. The cone-collector 122 may be tapered, having a first-end 124 being substantially smaller than a second-end 126. The second-end 126 of the cone-collector 122 may be attachable to the aperture 144, and the first-end 124 may be attachable to the wind power-generator 110. The cone-collector 122 may be configured to funnel wind to the wind power-generator 110.

At least one support-pole 130 may be attachable to the curtain-frame 120, and is configured to support the curtain-frame 120 in a suspended state. The at least one support-pole 130 may comprise a semi-flexible material that may enable the at least one support-pole 130 to be arcuate. The at least one support-pole 130 may have a weighted-stabilizer 132 attached for adjustment to the curtain-frame 120.

At least one battery 128 for storing the power collected from the wind power-generator 110 may be included. A transmission means 146 may be connected to the wind power-generator 110 for transmitting energy generated from the turbine-blades 114 to the battery 128. The power may thus be wirelessly transferred from the wind power-generator 110 to the battery 128 for storage and later usage.

The present disclosure may be advantageous by providing the power generating apparatus 100 which may be configured to be anchored along a shoreline 10 of a body of water 15 above the expected storm-surge. A deck 136 may be provided for supporting the curtain-frame 120 above the expected storm-surge. The deck 136 may include at least four legs 138 anchored to the shoreline 10.

According to one embodiment, the power-generating apparatus 100 may be arranged as a kit. In particular, the power-generating apparatus 100 may further include a set of instructions 107. The instructions 107 may detail functional relationships in relation to the structure of the power-generating apparatus 100 such that the power-generating apparatus 100 can be used, maintained, or the like, in a preferred manner.

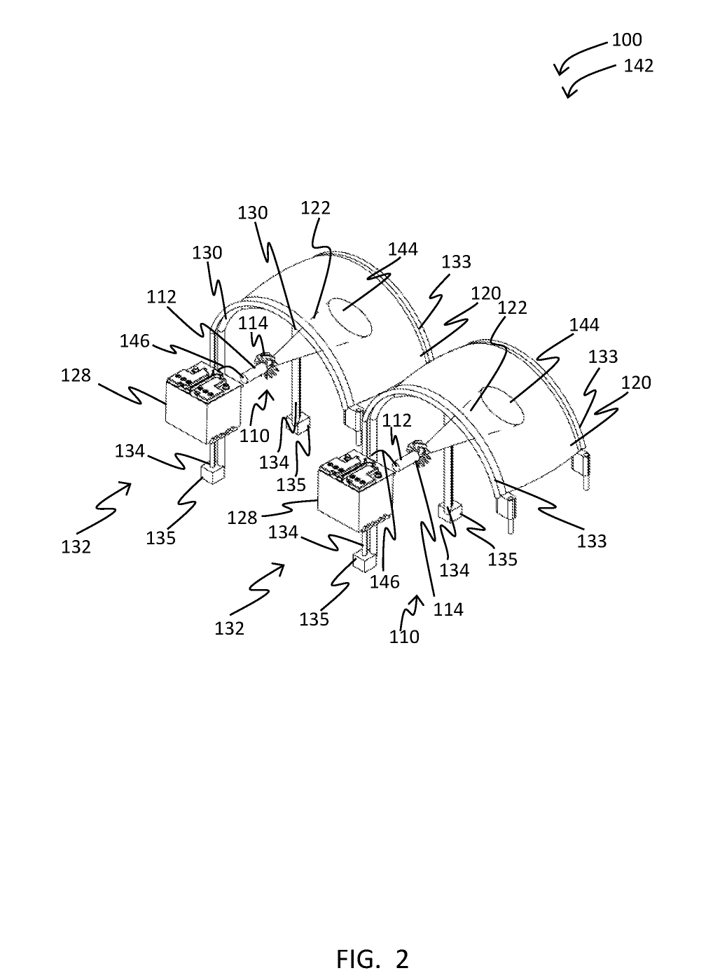

FIG. 2 shows the power-generating apparatus 100 of FIG. 1, according to an embodiment of the present disclosure. As above, the power-generating apparatus 100 may include the wind power-generator 110. The wind power-generator 110 may include the body 112 having the turbine-blades 114. The curtain-frame 120 may be coupled to the wind power-generator 110 via the cone-collector 122. The cone-collector 122 may be configured to funnel wind to the wind power-generator 110. The at least one support-pole 130 may be attachable to the curtain-frame 120, and configured to support the curtain-frame 120 in the suspended state. The at least one support-pole 130 may include the weighted-stabilizer 132 attached for adjustment to the curtain-frame 120.

The curtain-frame 120 in preferred embodiments may include an angle of no more than 90 degrees, and the angle is adjustable via the weighted-stabilizer 132. Angles of the curtain-frame 120 may allow the maximum amount of exposure to the wind. Wind currents may often change direction according to weather patterns, and the power-generating apparatus 100 may utilize the weighted-stabilizer 132 for adjusting to current changes. The weighted-stabilizer 132 may include a top-end 133 and a bottom-end 134; the bottom-end 134 having a weight 135 and the top-end 133 attached to the at least one support-pole 130. The weight 135 may be increased or decreased to accommodate the desired angle of the curtain-frame 120.

The curtain-frame 120 may be substantially square-shaped; however, other ergonomically shaped curtain-frames 120 may be contemplated according to the present disclosure. The curtain-frame 120 may comprise a para-aramid synthetic fiber. Such a material may withstand any damage from weather. Additionally, the material may be slippery and able to resist penetration of water.

In another embodiment of the present disclosure, two or more of the power-generating apparatus 100 may be implemented in a parallel array 142. One or more batteries 128 may be utilized with the parallel array 142 for storing the maximum amount of energy generated by the wind power-generators 110.

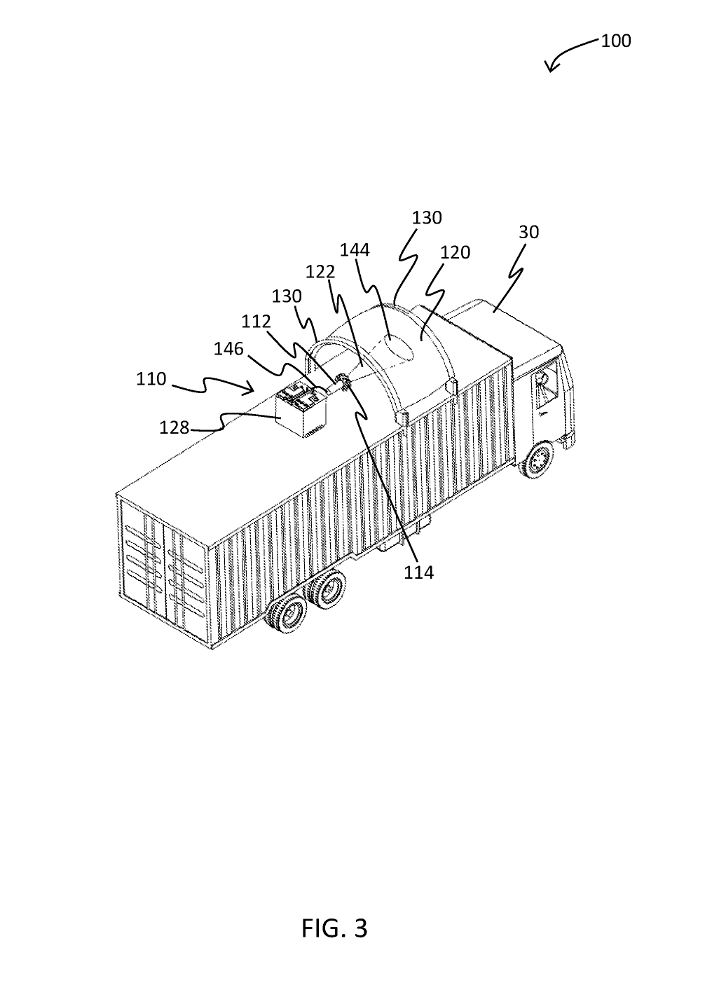

FIG. 3 is a perspective view of the power-generating apparatus 100 of FIG. 1, according to an embodiment of the present disclosure. The power-generating apparatus 100 may be anchored to a vehicle 30. The vehicle 30 may be advantageous in providing increased exposure to wind when in motion.

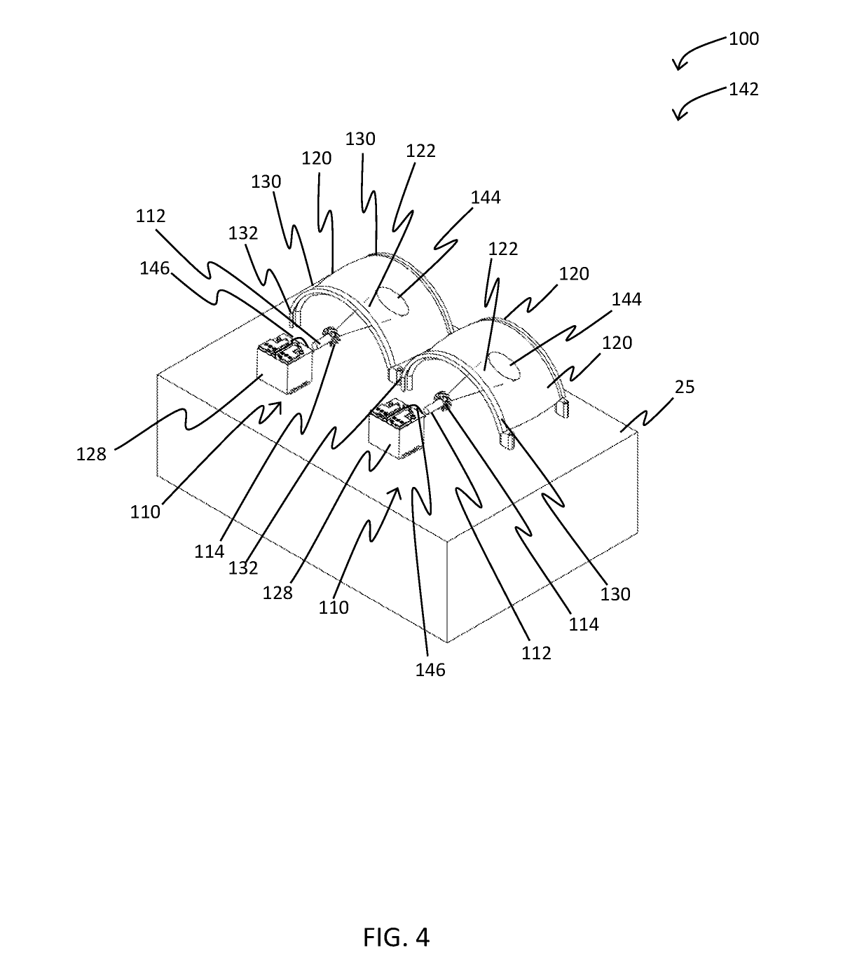

FIG. 4 is a perspective view of the power-generating apparatus 100 of FIG. 1, according to an embodiment of the present disclosure. The power-generating apparatus 100 may be anchored at a ground level 25. The ground level 25 may be advantageous in providing accessibility to the power-generating apparatus 100. Maintenance of the power-generating apparatus 100 may be conveniently sustained from the ground level 25. In yet another embodiment, the power-generating apparatus 100 may be anchored to a pair of rail-road tracks (not shown).

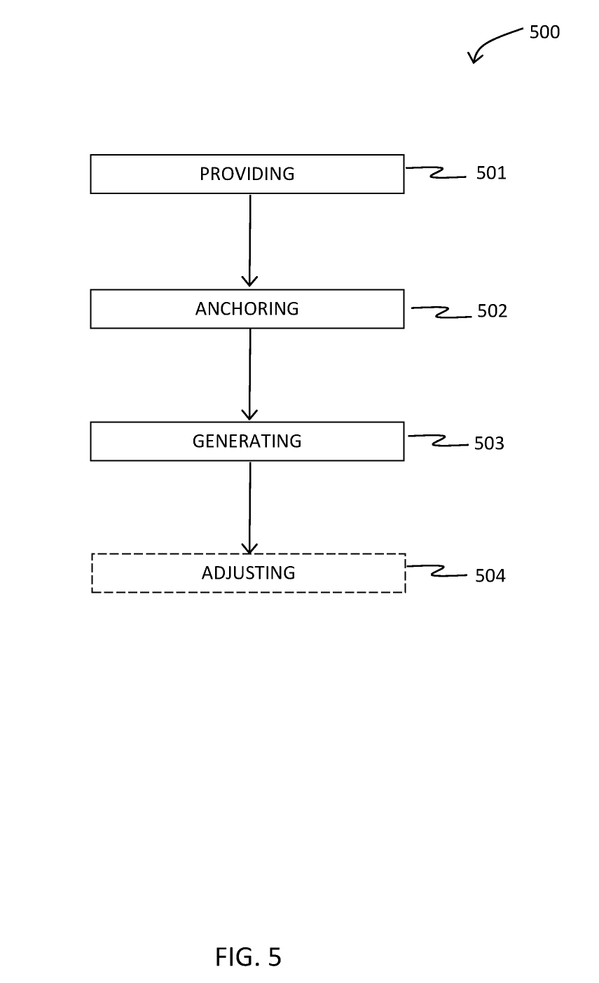

FIG. 5 is a flow diagram illustrating a method for using 500 a power-generating apparatus 100, according to an embodiment of the present disclosure. In particular, the method for using 500 a power-generating apparatus 100 may include one or more components or features of the power-generating apparatus 100 as described above. As illustrated, the method for using 500 a power-generating apparatus 100 may include the steps of: step one 501, providing a wind power-generator; the wind power-generator including a body having turbine-blades, a curtain-frame coupled to the wind power-generator, and at least one support-pole attachable to the curtain-frame; step two 502, anchoring the at least one support-pole above an expected storm-surge; step three 503, generating power from the wind power-generator; and step four 504, adjusting an angle of the curtain-frame via a weighted-stabilizer coupled to the at least one support-pole.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the power-generating apparatus 100 (e.g. anchoring the at least one support-pole to other surfaces) are taught herein. Upon reading this specification, it should be appreciated that, under appropriate circumstances, considering such issues as user preferences, design preference, structural requirements, marketing preferences, cost, available materials, technological advances, etc., other power-generating apparatus 100 arrangements such as, for example, anchoring the at least one support-pole 130 to a barge, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A power-generating apparatus, the apparatus comprising:
a wind power-generator, said wind power-generator including a body having turbine-blades;
a curtain-frame coupled to the wind power-generator, the curtain-frame having, a cone-collector configured to funnel wind to the wind power-generator, and a battery for storing the power collected from the wind power-generator; and
at least one support-pole attachable to the curtain-frame, and configured to support the curtain-frame in a suspended state, the at least one support-pole having,
a weighted-stabilizer for adjustment to the curtain-frame; and wherein the power-generating apparatus is configured to be anchored along a shoreline of a body of water above an expected storm-surge.

2. The power-generating apparatus of claim 1, further comprising a deck having at least four legs anchored to a bottom of the shoreline and configured to support the curtain-frame above the expected storm-surge.

3. The power-generating apparatus of claim 1, wherein the power-generating apparatus is anchored at a ground level.

4. The power-generating apparatus of claim 1, wherein the power-generating apparatus is anchored to a vehicle.

5. The power-generating apparatus of claim 1, wherein the power-generating apparatus is anchored to a pair of rail-road tracks.

6. The power-generating apparatus of claim 1, wherein two or more of the power-generating apparatus are implemented in a parallel array.

7. The power-generating apparatus of claim 1, wherein the at least one support-pole comprises a semi-flexible material.

8. The power-generating apparatus of claim 7, wherein the at least one support-pole is arcuate.

9. The power-generating apparatus of claim 1, wherein the cone-collector is tapered, having a first-end being substantially smaller than a second-end.

10. The power-generating apparatus of claim 9, wherein the curtain-frame includes an aperture, and the second-end of the cone-collector is attachable to the aperture; and
wherein the first-end is attachable to the wind power-generator.

11. The power-generating apparatus of claim 1, wherein the turbine-blades are rotateably mounted to the body of the wind power-generator.

12. The power-generating apparatus of claim 1, wherein a transmission means is connected to the wind power-generator for transmitting energy generated from the turbine-blades to the battery.

13. The power-generating apparatus of claim 1, wherein the curtain-frame includes an angle of no more than 90 degrees, and the angle is adjustable via the weighted-stabilizer.

14. The power-generating apparatus of claim 1, wherein the weighted-stabilizer includes a top-end and a bottom-end, the bottom-end having a weight and the top-end attached to the at least one support-pole.

15. The power-generating apparatus of claim 1, wherein the curtain-frame is substantially square-shaped.

16. The power-generating apparatus of claim 1, wherein the curtain-frame comprises a para-aramid synthetic fiber.

17. A power-generating apparatus, the apparatus comprising:
a wind power-generator, said wind power-generator including a body having turbine-blades;
a curtain-frame coupled to the wind power-generator, the curtain-frame having, a cone-collector configured to funnel wind to the wind power-generator, and a battery for storing the power collected from the wind power-generator;
at least one support-pole attachable to the curtain-frame, and configured to support the curtain-frame in a suspended state, the at least one support-pole having,
a weighted-stabilizer for adjustment to the curtain-frame;
wherein the power generating apparatus is configured to be anchored along a shoreline of a body of water above an expected storm-surge;
further comprising a deck having at least four legs anchored to a bottom of the shoreline and configured to support the curtain-frame above the expected storm-surge;
wherein two or more of the power generating apparatus are implemented in a parallel array;
wherein the at least one support-pole comprises a semi-flexible material;
wherein the at least one support-pole is arcuate;
wherein the cone-collector is tapered, having a first-end being substantially smaller than a second-end;
wherein the curtain-frame includes an aperture, and the second-end of the cone-collector is attachable to the aperture; and
wherein the first-end is attachable to the wind power-generator;
wherein the turbine-blades are rotateably mounted to the body of the wind power-generator;
wherein a transmission means is connected to the wind power-generator for transmitting energy generated from the turbine-blades to the battery;
wherein the curtain frame includes an angle of no more than 90 degrees, and the angle is adjustable via the weighted-stabilizer;
wherein the weighted-stabilizer includes a top-end and a bottom-end, the bottom end having a weight and the top-end attached to the at least one support-pole;
wherein the curtain-frame is substantially square-shaped; and
wherein the curtain-frame comprises a para-aramid synthetic fiber.

18. The power-generating apparatus of claim 17, further comprising set of instructions; and
wherein the power-generating apparatus is arranged as a kit.

19. A method of using a power-generating apparatus, the method comprising the steps of:
providing a wind power-generator, said wind power-generator including a body having turbine-blades, a curtain-frame coupled to the wind power-generator, and at least one support-pole attachable to the curtain-frame;
anchoring the at least one support-pole above an expected storm-surge; and
generating power from the wind power-generator.

20. The method of claim 19, further comprising the steps of
adjusting an angle of the curtain-frame via a weighted-stabilizer coupled to the at least one support-pole.
